(19) United States
(12) Patent Application Publication
(10) Pub. No.: US 2025/0358071 A1
(43) Pub. Date: Nov. 20, 2025

(54) TECHNIQUES FOR CLUSTER-BASED SYNCHRONIZATION SIGNAL BLOCK TRANSMISSION

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US)

(21) Appl. No.: 19/285,855

(22) Filed: Jul. 30, 2025

(51) Int. Cl. H04L 5/00; H04W 48/08

(52) U.S. Cl. CPC H04L 5/005; H04L 5/0007; H04W 48/08

(57) ABSTRACT

Various aspects of the present disclosure relate to techniques for cluster-based synchronization signal block (SSB) transmission. A network entity is configured to configure a first plurality of SSB bursts for transmission within a first time window, transmit the first plurality of SSB bursts as an SSB burst cluster within the first time window, and periodically transmit one or more second plurality of SSB bursts as SSB burst clusters within one or more second time windows at a periodicity that is greater than a standard SSB burst periodicity.

### TECHNICAL FIELD

The present disclosure relates to wireless communications, and more specifically to techniques for cluster-based synchronization signal block (SSB) transmission.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

An NE for wireless communication is described. The NE may be configured to, capable of, or operable to configure a first plurality of SSB bursts for transmission within a first time window, transmit the first plurality of SSB bursts as an SSB burst cluster within the first time window, and periodically transmit one or more second plurality of SSB bursts as SSB burst clusters within one or more second time windows at a periodicity that is greater than a standard SSB burst periodicity.

A processor for wireless communication is described. The processor may be configured to, capable of, or operable to configure a first plurality of SSB bursts for transmission within a first time window, transmit the first plurality of SSB bursts as an SSB burst cluster within the first time window, and periodically transmit one or more second plurality of SSB bursts as SSB burst clusters within one or more second time windows at a periodicity that is greater than a standard SSB burst periodicity.

A method for wireless communication performed by a NE is described. The method may be configured to, capable of, or operable to configure a first plurality of SSB bursts for transmission within a first time window, transmit the first plurality of SSB bursts as an SSB burst cluster within the first time window, and periodically transmit one or more second plurality of SSB bursts as SSB burst clusters within one or more second time windows at a periodicity that is greater than a standard SSB burst periodicity.

A UE for wireless communication is described. The UE may be configured to, capable of, or operable to monitor for a first plurality of SSB bursts within a first time window, detect at least one synchronization signal from the first plurality of SSB bursts, and synchronize to a network using the at least one synchronization signal, wherein the UE expects subsequent pluralities of SSB bursts to be received periodically in one or more second time windows separated by a periodicity that is greater than a standard SSB burst periodicity.

A processor for wireless communication is described. The processor may be configured to, capable of, or operable to monitor for a first plurality of SSB bursts within a first time window, detect at least one synchronization signal from the first plurality of SSB bursts, and synchronize to a network using the at least one synchronization signal, wherein a UE expects subsequent pluralities of SSB bursts to be received periodically in one or more second time windows separated by a periodicity that is greater than a standard SSB burst periodicity.

A method for wireless communication performed by a NE is described. The method may be configured to, capable of, or operable to monitor for a first plurality of SSB bursts within a first time window, detect at least one synchronization signal from the first plurality of SSB bursts, and synchronize to a network using the at least one synchronization signal, wherein a UE expects subsequent pluralities of SSB bursts to be received periodically in one or more second time windows separated by a periodicity that is greater than a standard SSB burst periodicity.

### BRIEF DESCRIPTION OF THE DRAWINGS

FIG. 1 illustrates an example of a wireless communications system, in accordance with aspects of the present disclosure.

FIG. 2A illustrates an embodiment of a non-uniform SSB burst transmission using SSB burst clustering, in accordance with aspects of the present disclosure.

FIG. 2B illustrates an embodiment of a non-uniform SSB burst transmission using SSB burst clustering, in accordance with aspects of the present disclosure.

FIG. 2C illustrates an embodiment of a non-uniform SSB burst transmission using SSB burst clustering, in accordance with aspects of the present disclosure.

FIG. 3A illustrates an embodiment of a lean SSB, in accordance with aspects of the present disclosure.

FIG. 3B illustrates an embodiment of a lean SSB, in accordance with aspects of the present disclosure.

FIG. 4 depicts one embodiment of a mapping of SSBs and random access channel (RACH) occasions (ROs), in accordance with aspects of the present disclosure

FIG. 5 illustrates an example of a UE, in accordance with aspects of the present disclosure.

FIG. 6 illustrates an example of a processor, in accordance with aspects of the present disclosure.

FIG. 7 illustrates an example of an NE, in accordance with aspects of the present disclosure.

FIG. 8 illustrates a flowchart of a method performed by an NE, in accordance with aspects of the present disclosure.

FIG. 9 illustrates a flowchart of a method performed by a UE, in accordance with aspects of the present disclosure.

### DETAILED DESCRIPTION

Generally, the present disclosure describes systems, methods, and apparatuses for techniques for cluster-based synchronization signal block transmission. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In New Radio (NR) systems, SSBs are transmitted periodically by the base station (gNB) to facilitate cell search, synchronization, and system information decoding by UE. A typical SSB includes a primary synchronization signal (PSS), a secondary synchronization signal (SSS), and a physical broadcast channel (PBCH). The SSBs are transmitted within a defined burst window, with a default periodicity of 20 milliseconds (ms), though longer periodicities such as 40 ms, 80 ms, or 160 ms are supported in 5G and under consideration for 6G to enable network energy savings.

However, increasing the periodicity of SSB transmissions introduces a trade-off by significantly increasing acquisition latency, especially for UEs in poor signal conditions. Such UEs often require reception of multiple SSBs (e.g., three or more) for reliable synchronization and decoding of minimum system information, such as the Master Information Block (MIB) and System Information Block 1 (SIB1). Consequently, extended SSB periodicities can hinder access performance, degrade paging responsiveness, and delay random access procedures.

To address this challenge, the subject matter disclosed herein describes solutions for transmitting SSBs in a clustered or bundled configuration. Rather than spacing SSB bursts uniformly at long periodic intervals, a base station may be configured to transmit a plurality of SSB bursts closely grouped in time, within a designated SSB cluster window. These clusters may be transmitted periodically at a relatively long periodicity (e.g., 80 ms, 160 ms), allowing the network to enter a deep sleep state between clusters and reduce energy consumption, while still offering UEs multiple synchronization opportunities within a short acquisition time.

In one embodiment, each SSB cluster comprises two or more SSB bursts transmitted within a time window (e.g., 5-10 ms), and the inter-burst gap within the cluster may be defined in terms of time, symbol offset, or slot spacing. In some implementations, all SSB bursts in the cluster may share a uniform structure (e.g., containing full PSS/SSS/PBCH blocks). In alternative implementations, the cluster may comprise a mix of regular SSBs and lean SSBs, the latter including only essential synchronization components such as PSS and SSS, or PSS, SSS, and partial PBCH, to reduce overhead while maintaining synchronization coverage.

The proposed solution also enables flexibility in mapping physical layer resources and control information. For example, only a subset of the SSB bursts in a cluster may be associated with core resource set #0 (CORESET #0) for SIB1 scheduling, and ROs may be mapped selectively to reduce signaling overhead. Additionally, muting strategies may be applied to individual SSBs, SSB bursts, or entire clusters based on network conditions, enabling dynamic adaptation of SSB transmission patterns in time and frequency domains.

This clustered SSB burst transmission framework reduces network energy consumption by enabling longer inactive intervals between transmissions and minimizes UE acquisition delay by providing rapid access to multiple synchronization signals within a compact time window.

Aspects of the present disclosure are described in the context of a wireless communications system. Note that one or more aspects from different solutions may be combined.

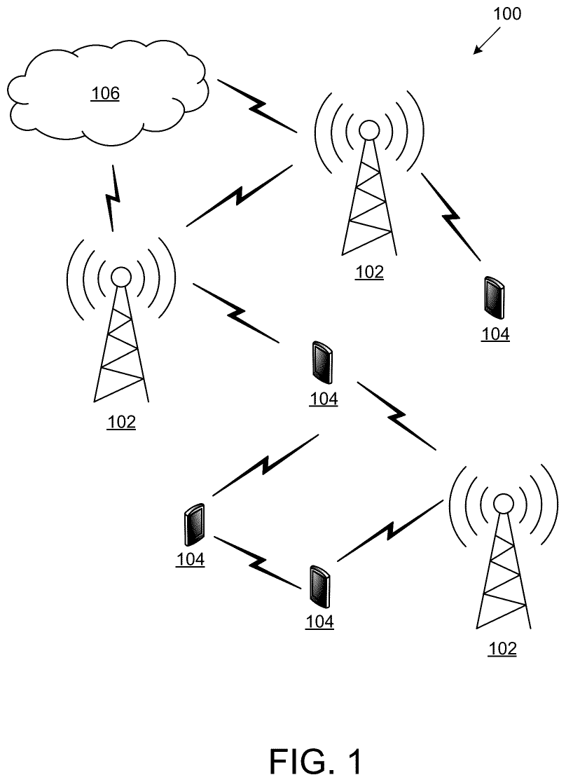

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHZ), FR3 (7.125 GHz-24.25 GHZ), FR4 (52.6 GHz-114.25 GHZ), FR4a or FR4-1 (52.6 GHZ-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In NR systems, e.g., as shown in FIG. 1, SSBs are transmitted periodically to facilitate initial access, time-frequency synchronization, and reception of minimum system information by a UE. The SSB burst structure spans a 5-millisecond (ms) window and typically includes a PSS, an SSS, and a PBCH. Each SSB occupies four Orthogonal Frequency Division Multiplexing (OFDM) symbols and 240 subcarriers, and the default periodicity for SSB transmission is 20 ms. The number of SSBs that can be transmitted within a burst depends on the frequency range and subcarrier spacing (SCS); for example, 8 SSBs are supported in FR1 and up to 64 SSBs in FR2.

For 6G systems, particularly those utilizing extremely large multiple input-multiple output (XL-MIMO) configurations-such as 256 transmit-receive units and arrays of 1024 antenna elements-a significantly larger number of SSBs may be required to ensure spatial coverage and beamforming support. However, transmitting such a large number of SSBs within the conventional 5 ms SSB burst window presents scalability challenges. With 2 SSBs per slot, approximately 40 SSBs can be transmitted in 5 ms. This number may increase to around 60 SSBs by minimizing or eliminating the symbol gap and transmitting 3 SSBs per slot. Nonetheless, even this is insufficient for supporting up to 256 candidate SSBs, necessitating a reevaluation of the SSB structure and its association with other physical channels, such as ROs and CORESET #0.

Furthermore, although NR specifications allow for transmission of 8 SSBs within 4 ms (using 15 kHz or 30 KHz SCS) or 64 SSBs within 4.5 ms (using 120 kHz SCS), the introduction of more compact SSB structures—with no symbol gap between SSBs—could enable transmission of the same number of SSBs in under 3 ms. This compact SSB design not only reduces SSB transmission latency but also allows the base station (gNB) to transition into an active cell state more rapidly, improving responsiveness and reducing UE acquisition time.

These limitations in conventional NR designs highlight the need for more flexible and scalable SSB transmission mechanisms that can accommodate a higher number of SSBs in time-constrained windows while enabling network energy savings and minimizing access delays.

As used herein, the term “SS/PBCH block” refers to a synchronization signal and physical broadcast channel block as defined in 5G NR. Each block includes four OFDM symbols and comprises PSS, an SSS, and a PBCH. The PSS occupies the first OFDM symbol, the SSS is located in the third symbol, and the PBCH spans the second and fourth symbols as well as portions of the third symbol.

A “Synchronization Signal Block” or SSB may refer to a transmission unit consisting of one SS/PBCH block. SSBs are used to support initial cell search, time and frequency synchronization, and broadcast of key system information to UE. An “SSB burst” is a set of SSBs transmitted within a predefined burst window, typically a 5-millisecond half-frame. Each SSB within the burst is transmitted at a designated time and spatial beam direction based on configuration parameters such as subcarrier spacing and frequency range. The periodicity of SSB bursts in NR can range from 5 ms to 160 ms, with a default of 20 ms assumed by the UE unless otherwise indicated in SIB1.

An “SSB cluster” or “SSB group” refers to a grouping of two or more SSB bursts transmitted in close temporal proximity within a defined cluster window. This approach allows dense SSB transmission for fast acquisition, while enabling long inactive intervals between clusters to support network energy savings. Within this framework, a “Cell-Defining SSB” (CD-SSB) refers to an SSB that is associated with CORESET #0 for scheduling SIB1 and is transmitted at a designated raster frequency. In contrast, a “Non Cell-Defining SSB” (NCD-SSB) is not associated with CORESET #0 and/or is not transmitted in the raster frequency.

“CORESET #0” designates a specific set of physical downlink control channel (PDCCH) resources that are associated with CD-SSBs and used to convey scheduling information for SIB1. The term “lean SSB” denotes a reduced version of an SSB structure that includes only the synchronization signals (e.g., PSS and SSS) or the synchronization signals plus a partial PBCH, thereby minimizing time-domain and spectral overhead. A “regular SSB” contains the full complement of PSS, SSS, and the complete PBCH payload.

The “Master Information Block” or MIB refers to system information transmitted via the PBCH that provides fundamental configuration parameters required for decoding SIB1 and for UE system access. The “System Information Block 1” or SIB1 includes essential cell-specific configuration, system service availability, and scheduling information for other SIBs. “Remaining Minimum System Information” or RMSI refers to system information beyond the MIB that is required for basic network operation, including SIB1. The term “raster frequency” refers to a predefined frequency grid used for aligning CD-SSB transmissions, ensuring consistent and reliable UE acquisition across varying deployment scenarios.

In one example embodiment, a single SSB configuration is employed in which a plurality of SSB bursts are grouped, clustered, or bundled together within a defined time window. This grouping enables a longer periodicity between successive SSB clusters, thereby allowing the base station or gNB to transition into a deep sleep state during the inactive intervals. Importantly, the total number or density of SSBs transmitted over time can be maintained at a level comparable to conventional configurations using shorter SSB periodicities, while achieving improved energy efficiency and reduced acquisition latency for UE.

Described herein, multiple structural variants of the clustered SSB configuration are contemplated. In a first variant, each SSB burst within a cluster has the same structure, such as a standard SSB comprising a PSS, an SSS, and a full PBCH. In a second variant, the cluster includes SSB bursts with differing structures-specifically, one or more lean SSBs containing only the PSS and SSS or the PSS, SSS, and a portion of the PBCH, in combination with regular SSBs containing the full PSS/SSS/PBCH structure. The first two variants may be a cell defining SSB. In a third variant, the first SSB burst within a cluster may be a non-cell-defining SSB (NCD-SSB), which may omit association with CORESET #0 and/or may be transmitted outside the raster frequency designated for SSB transmissions.

The clustered SSB configuration may include several key parameters. These include the definition of the SSB cluster or group window and its associated periodicity, the number of SSB bursts contained within each cluster, the mapping of individual SSB bursts within the cluster, and the time gap between SSB bursts in a cluster, which may be fixed or variable. Additionally, the mapping of CORESET #0—which carries scheduling information for SIB1—may follow one of several approaches. In one option, each SSB burst within the cluster is associated with its own CORESET #0 instance. In another option, CORESET #0 is mapped only to a designated SSB burst within the cluster, such as the final burst in the group.

Furthermore, adaptive transmission techniques may be employed to control the number and timing of SSB transmissions within and across clusters. In one approach, one or more SS/PBCH blocks (i.e., SSBs) within a burst may be muted. These muted blocks may occupy either identical or different time-domain locations across successive SSB bursts in the cluster. In a second approach, entire SSB bursts within a cluster may be muted. In a third approach, one or more entire SSB clusters may be muted. These muting strategies may be dynamically selected based on network conditions, load levels, or energy-saving objectives, and may be signaled through higher-layer control information or broadcast system information.

In typical wireless systems, the power consumption associated with periodic transmission of common channels, including SSBs, is inversely related to the configured periodicity-longer periodicities generally reduce power consumption by allowing longer inactive durations for the BS. For example, in NR, SSB burst periodicities may range from 5 ms to 160 ms. However, in a first example, increasing the SSB burst periodicity (e.g., to 160 ms) may introduce substantial cell acquisition delays, particularly for UEs located in poor signal conditions. In such cases, the UE may require multiple SSBs—such as three or more—to achieve sufficient time-frequency synchronization before decoding essential channels such as the paging channel or SIB1.

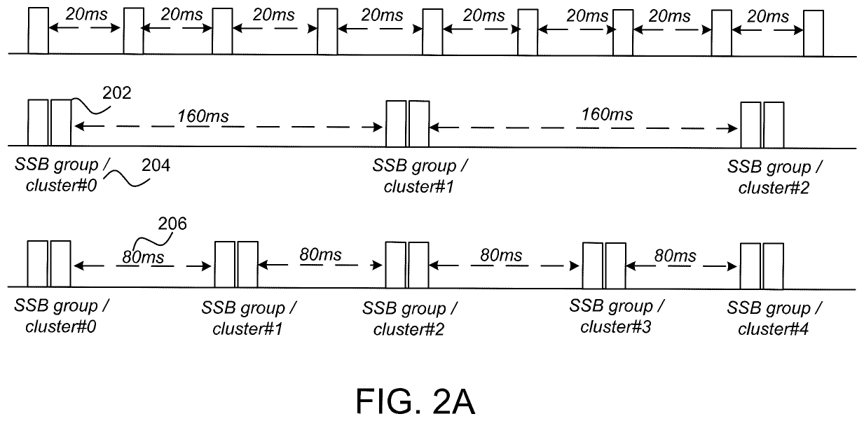

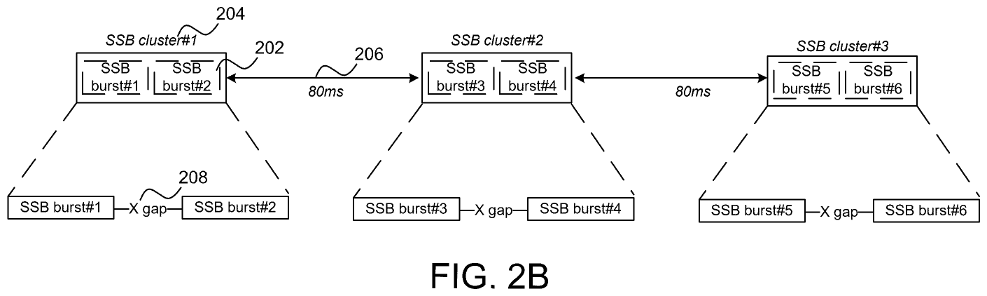

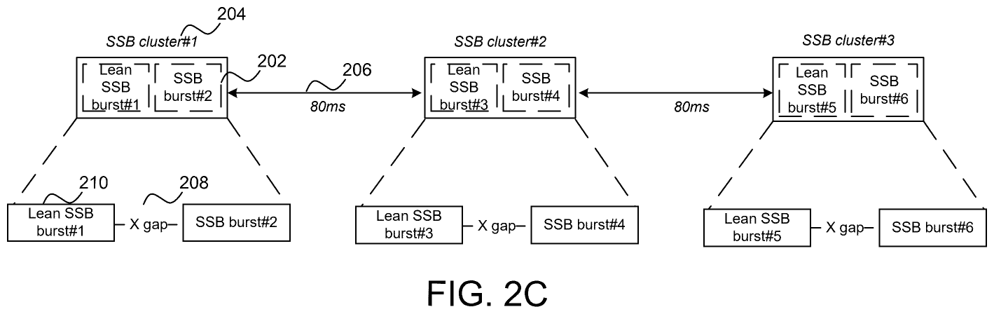

FIGS. 2A and 2B illustrate embodiments of a non-uniform SSB burst transmission using SSB burst clustering, in accordance with aspects of the present disclosure. In an example implementation, the BS may be configured to transmit a plurality of SSB 202 bursts grouped together as a cluster 204 within a defined time window. The cluster 204 may be transmitted periodically at a configurable periodicity 206, such as 40 ms or 80 ms. Within the cluster 204, each SSB burst 202 may be separated from the next by a configurable time offset—referred to as the inter-SSB burst gap 208—which may, in some implementations, be set to values such as 0 ms, 2 ms, 5 ms, 10 ms, or 20 ms. In one example, the inter-burst gap 208 may be defined as the offset between the last symbol of the last SSB in one burst 202 and the first symbol of the first SSB in the subsequent burst 202. Alternatively, the inter-burst gap 208 may be specified in terms of a number of OFDM symbols or slots between SSB bursts 202. In another example, the starting OFDM symbols of the candidate SSBs in a cluster can be defined using a formula also considering inter-SSB burst gap. For example, (2, 8)+14*n where n=0, 1, 3, 4, the starting OFDM symbols for SS/PBCH block can be 2, 8, 16, 22, 44, 52, 58, 64. Hence the extension using non-contiguous n value containing gap includes inter-SSB burst gap, where OFDM symbols 2, 8, 16, 22 can be defined as the first SSB burst and 44, 52, 58, 64 can be considered as the second SSB burst with inter-SSB gap of 22 OFDM symbols.

In another example, each SSB burst in a cluster may be transmitted within a half-frame of 5 ms or less, depending on the number of SSBs per slot and the subcarrier spacing. For instance, if 3 SSBs are accommodated per slot by reducing inter-SSB symbol gaps, the burst duration may be reduced to approximately 2-3 ms. In one example, 8 SSBs could be transmitted within 3 ms, enabling two such bursts to be transmitted contiguously within 6 ms. In another example, a 2 ms gap may be inserted between the two bursts, resulting in a total cluster duration of approximately 8 ms. The SSB bursts within a cluster may, in some implementations, be transmitted using the same half-frame index (e.g., all in the first half of the radio frame), or may alternatively be distributed across different half-frame indices (e.g., one in the first half and one in the second half of the frame).

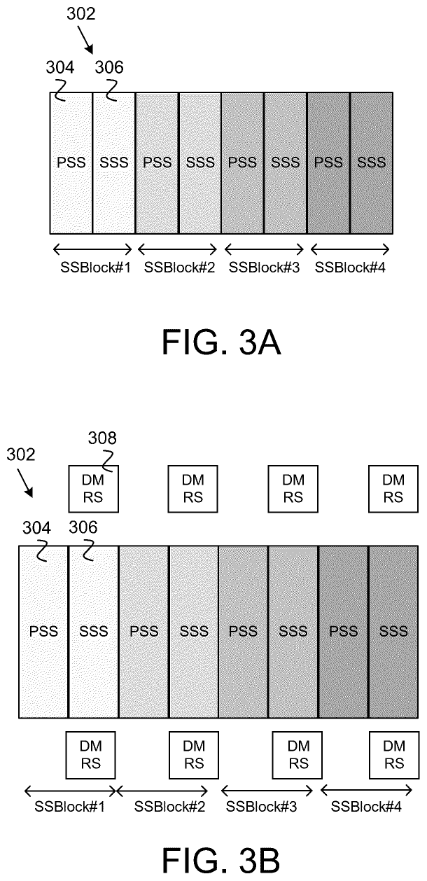

FIG. 2C illustrates an embodiment of a non-uniform SSB burst transmission using SSB burst clustering, in accordance with aspects of the present disclosure. In a second variant of this example, a cluster 204 may include a mixture of lean SSB bursts 204 and regular SSB bursts 202. FIGS. 3A and 3B illustrate embodiments of lean SSBs, in accordance with aspects of the present disclosure. In one example, a lean SSB 302 in a lean SSB burst 210 may contain only the PSS 304 and SSS 306 or may further include a portion of the PBCH 308. Regular SSBs of a regular SSB burst 202 may include the full PSS, SSS, and complete PBCH. Because UEs typically require multiple synchronization signals before decoding other common channels, including paging, the use of multiple lean SSBs may reduce acquisition latency without incurring the full resource overhead of repeated regular SSBs. Lean SSBs may, for instance, be shorter in duration—spanning 2 or 3 OFDM symbols—and allow a greater number of synchronization signals to be packed into a given slot.

In one example implementation, partial PBCH 308 content may be embedded within the same OFDM symbol as the SSS 306, using, for example, four resource blocks above and below the SSS 306 subcarriers. In an example scenario, assuming QPSK modulation and a similar code rate to the full PBCH, the partial PBCH 308 may support a reduced payload (e.g., 8 bits) sufficient to convey identification information such as an SSB index. In one example, a lean SSB burst 210 may include 4 or 5 lean SSBs per slot and be completed within approximately 2 ms, while a regular SSB burst 202 may span 3 ms. Accordingly, a cluster 204 combining both burst types 202, 210 may fit within a half-frame (e.g., 5 ms).

In a third variant of this example, one or more SSB bursts within a cluster may be configured as NCD bursts. In one example, the first burst in a cluster may not be associated with CORESET #0 and may optionally be transmitted on a frequency that does not correspond to the SSB raster frequency. A frequency offset may be applied, for example, in terms of a defined number of subcarriers, PRBs, or a specific offset value based on subcarrier spacing. In some implementations, different variants described herein may be combined to provide greater flexibility and adaptability in cluster design.

This clustered SSB burst transmission framework, including optional use of lean SSBs, configurable burst spacing, and frequency-domain diversity, supports improved UE acquisition performance under extended periodicity while enabling the BS to reduce energy consumption through longer inactive intervals.

In a second example, the mapping of SSBs to CORESET #0—used for scheduling SIB1—may be adapted to support clustered SSB burst transmission. In conventional systems, each synchronization signal block (SS/PBCH block) is typically associated with a corresponding CORESET #0. However, in the clustered SSB framework, alternative mapping strategies may be applied to reduce signaling overhead or enable flexible scheduling behavior.

In one example implementation, CORESET #0 may be associated with each SSB burst within a cluster. That is, every SS/PBCH block in the cluster may be configured to carry or point to an instance of CORESET #0. This approach may ensure that UEs synchronizing to any SSB burst in the cluster can promptly acquire scheduling information for SIB1, thereby improving access speed and robustness, particularly in scenarios involving variable UE timing or channel conditions.

In another example implementation, CORESET #0 may be mapped only to a designated SSB burst within the cluster-such as the second or final burst in the group. In this configuration, the SS/PBCH blocks in the earlier burst(s) within the cluster may either omit CORESET #0 association entirely or may be transmitted on a frequency that is not aligned with the designated raster frequency. The designated SSB burst associated with CORESET #0 may, in some implementations, be transmitted at the raster frequency to facilitate UE acquisition and decoding.

This flexible mapping framework allows the system to balance acquisition latency, signaling overhead, and implementation complexity. It may be particularly useful in deployments with lean synchronization signaling or where energy efficiency is prioritized.

In a third example, the association between SSBs and ROs may be modified relative to the mapping rules defined in 5G NR. In conventional 5G NR systems, each transmitted SSB (or beam) is typically mapped to at least one RO, with the association period defining how frequently such mappings occur.

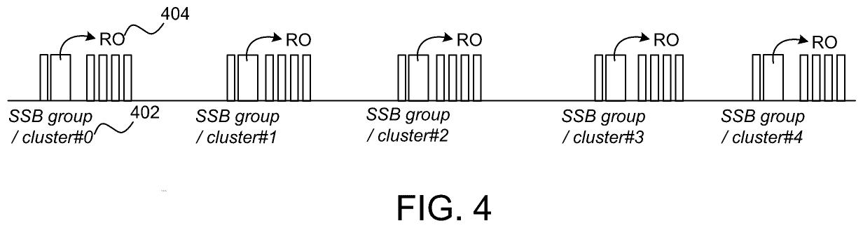

FIG. 4 illustrates one embodiment of a mapping of SSBs and ROs, in accordance with aspects of the present disclosure. In one example, each SSB and each SSB burst within a cluster 402 may be associated with a corresponding RO 404. This configuration may be suitable for deployments where fast and uniform random access responsiveness is desired across all SSBs in the cluster.

In another example, a subset of SSB bursts within a cluster 402 may be mapped to ROs 404. In this case, the association period and mapping rules may be defined only for those specific SSBs or SSB bursts that are designated for RACH triggering. The RMSI, such as that conveyed in SIB1, may include explicit signaling of the SSB burst indices that are mapped to RACH resources e.g., RMSI includes PBCH, SIB0, SIB1 etc. This approach may reduce overhead and improve flexibility by allowing certain SSB bursts within the cluster to serve purely for synchronization or broadcast purposes without initiating random access procedures. In one example, there could be an implicit association between SSB bursts and Ros. As a result, a lean SSB burst—containing only the PSS and SSS, or the PSS, SSS, and a partial PBCH—may not be associated with any RO. In another example, a lean SSB burst can be classified as a non-cell-defining SSB, and therefore, no RACH resources are associated with it.

This selective SSB-RACH mapping framework may provide benefits in scenarios where reduced access signaling is desired, or where resource constraints and energy efficiency are priorities. It also enables differentiated treatment of SSBs within a cluster, consistent with the broader design flexibility of the clustered SSB transmission architecture.

In a fourth example, the transmission behavior of SSBs may be dynamically adapted in both the time and spatial domains based on operating conditions such as cell load, deployment configuration, or power-saving objectives. Since periodic transmission of SSBs contributes to network-side power consumption, adapting the number, timing, and structure of SSBs offers an opportunity for energy efficiency improvements.

In one example, muting patterns may be applied to specific SSBs or groups of SSBs to reduce transmission activity during periods of low demand. These muting configurations may be defined within a control signaling structure such as a common search space (CSS), and parameters related to CSS periodicity and monitoring occasions may be conveyed in system information, such as the master system information (MSI) or RMSI. In some implementations, the CSS periodicity may be configured as an integer multiple of the SSB periodicity to align with system timing constraints.

Several muting options may be supported. In one option, one or more individual SS/PBCH blocks (i.e., SSBs) within a given SSB burst in a cluster may be muted. These muted SSBs may occupy the same time-domain location across multiple SSB bursts or, alternatively, may vary in time-domain location from one burst to the next within the cluster.

In a second option, one or more entire SSB bursts within a cluster may be muted. This approach may be used to reduce activity during specific sub-windows of the cluster while still preserving synchronization opportunities in the remaining bursts.

In a third option, entire SSB clusters may be muted for one or more periodic intervals. This configuration may be suitable for extremely low-load scenarios or where auxiliary mechanisms (e.g., wake-up signaling or paging optimization) are employed to maintain UE connectivity.

In a fourth option, the choice between periodic SSB transmission with a regular interval and cluster-based (irregular interval) transmission can be dynamically adapted based on the cell load. Under high cell load conditions, periodic SSB transmission with a regular interval is preferable, as it efficiently supports frequent UE arrivals. Conversely, for medium to low cell load scenarios where energy efficiency is a priority, cluster-based SSB transmission is more suitable, as it allows the cell to enter a deep sleep state. A threshold for SSB periodicity (e.g., 40 ms) can be used to determine the transmission mode: below the threshold, regular interval transmission is applied; above the threshold, cluster-based transmission is used. This adaptation can be signaled dynamically via DCI or semi-statically through RMSI, indicating whether the SSB transmission should follow a regular interval or a cluster-based pattern.

These adaptive muting strategies enable the network to tailor synchronization signal transmission behavior to current conditions, balancing acquisition performance with energy efficiency and spectral overhead.

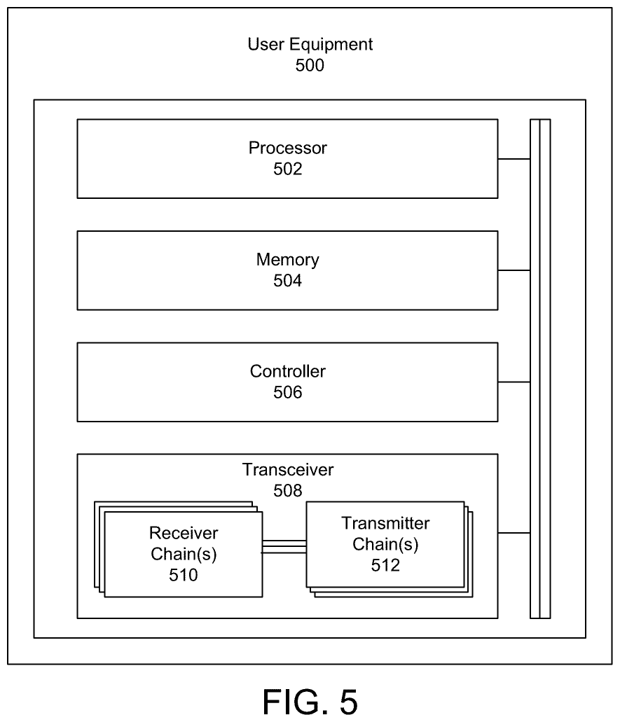

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, the UE 500 is configured to monitor for a first plurality of SSB bursts within a first time window, detect at least one synchronization signal from the first plurality of SSB bursts, and synchronize to a network using the at least one synchronization signal, wherein the UE 500 expects subsequent pluralities of SSB bursts to be received periodically in one or more second time windows separated by a periodicity that is greater than a standard SSB burst periodicity.

In one example, the UE 500 is configured to detect both lean SSBs and regular SSBs and initiate synchronization upon detection of multiple synchronization signals. In one example, the UE 500 is configured to monitor multiple half-frames within a radio frame for detecting SSB bursts transmitted with different half-frame indices.

In one example, the UE 500 is configured to use synchronization signals received from different SSB bursts within a same cluster to improve time-frequency synchronization prior to decoding a broadcast channel. In one example, the UE 500 is configured to decode a CORESET #0 associated with an SSB burst within the first plurality of SSB bursts, and to obtain scheduling information for SIB1 based on the CORESET #0.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

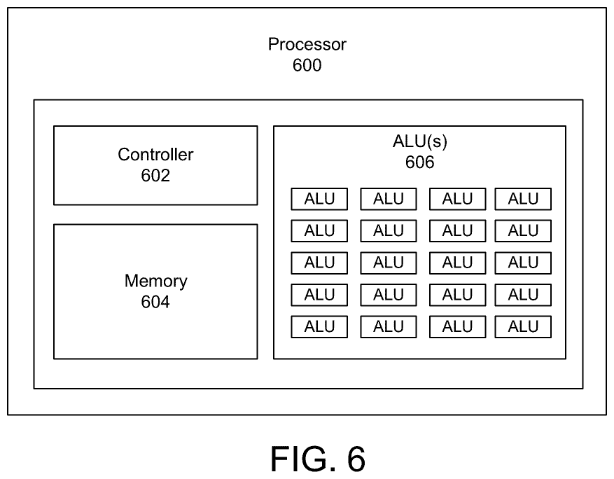

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, a processor 600 is configured to configure a first plurality of SSB bursts for transmission within a first time window, transmit the first plurality of SSB bursts as an SSB burst cluster within the first time window, and periodically transmit one or more second plurality of SSB bursts as SSB burst clusters within one or more second time windows at a periodicity that is greater than a standard SSB burst periodicity.

In one example, each SSB burst in the first plurality of SSB bursts comprises one or more SSBs transmitted within a half-frame of a radio frame. In one example, each SSB burst in the first plurality of SSB bursts is separated from another by a configurable time gap defined as an offset in OFDM symbols or slots between an end of a last SSB in a preceding burst and a start of a first SSB in a subsequent burst.

In one example, the periodicity is greater than 40 milliseconds. In one example, a number of SSBs transmitted across multiple SSB burst clusters over time is substantially equal to a number of SSBs transmitted using a lower SSB periodicity. In one example, at least one SSB burst in the first plurality of SSB bursts comprises a lean SSB that comprises a PSS and an SSS and omits at least a portion of a PBCH.

In one example, a first SSB burst within a cluster comprises a lean SSB and a second SSB burst within the cluster comprises a regular SSB containing the PSS, SSS, and a full PBCH. In one example, each SSB burst within the first plurality of SSB bursts is transmitted using a same half-frame index.

In one example, different SSB bursts within the first plurality of SSB bursts are transmitted using different half-frame indices. In one example, each SSB burst within the first plurality of SSB bursts is associated with a CORESET #0 for scheduling SIB1. In one example, a designated SSB burst in the first plurality of SSB bursts, comprising a regular SSB, is associated with a CORESET #0 for scheduling SIB1.

In one example, the designated SSB burst is a last SSB burst in a cluster and is transmitted in a raster frequency. In one example, one or more SSB bursts within the first plurality of SSB bursts are muted based on a predefined muting pattern.

In one example, the processor 600 is configured to monitor for a first plurality of SSB bursts within a first time window, detect at least one synchronization signal from the first plurality of SSB bursts, and synchronize to a network using the at least one synchronization signal, wherein a UE expects subsequent pluralities of SSB bursts to be received periodically in one or more second time windows separated by a periodicity that is greater than a standard SSB burst periodicity.

In one example, the processor 600 is configured to detect both lean SSBs and regular SSBs and initiate synchronization upon detection of multiple synchronization signals. In one example, the processor 600 is configured to monitor multiple half-frames within a radio frame for detecting SSB bursts transmitted with different half-frame indices.

In one example, the processor 600 is configured to use synchronization signals received from different SSB bursts within a same cluster to improve time-frequency synchronization prior to decoding a broadcast channel. In one example, the processor 600 is configured to decode a CORESET #0 associated with an SSB burst within the first plurality of SSB bursts, and to obtain scheduling information for SIB1 based on the CORESET #0.

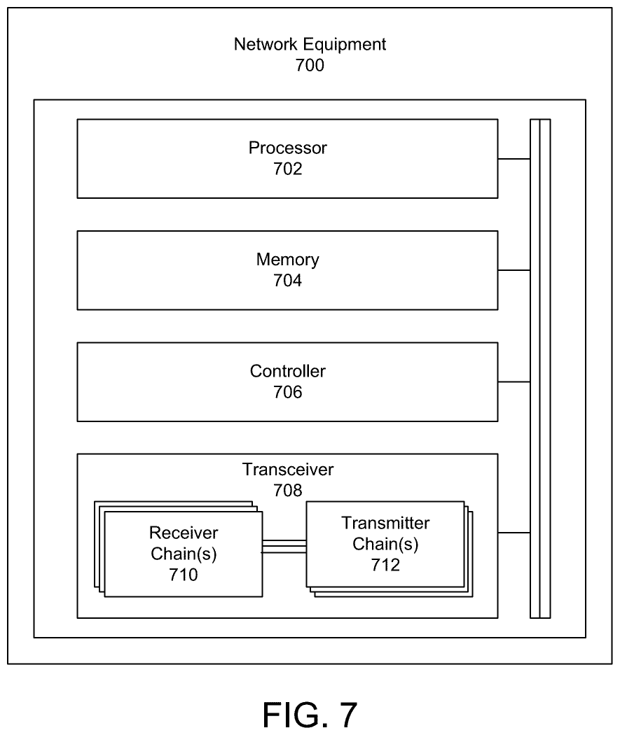

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one example, a NE 700 is configured to configure a first plurality of SSB bursts for transmission within a first time window, transmit the first plurality of SSB bursts as an SSB burst cluster within the first time window, and periodically transmit one or more second plurality of SSB bursts as SSB burst clusters within one or more second time windows at a periodicity that is greater than a standard SSB burst periodicity.

In one example, each SSB burst in the first plurality of SSB bursts comprises one or more SSBs transmitted within a half-frame of a radio frame. In one example, each SSB burst in the first plurality of SSB bursts is separated from another by a configurable time gap defined as an offset in OFDM symbols or slots between an end of a last SSB in a preceding burst and a start of a first SSB in a subsequent burst.

In one example, the periodicity is greater than 40 milliseconds. In one example, a number of SSBs transmitted across multiple SSB burst clusters over time is substantially equal to a number of SSBs transmitted using a lower SSB periodicity. In one example, at least one SSB burst in the first plurality of SSB bursts comprises a lean SSB that comprises a PSS and an SSS and omits at least a portion of a PBCH.

In one example, a first SSB burst within a cluster comprises a lean SSB and a second SSB burst within the cluster comprises a regular SSB containing the PSS, SSS, and a full PBCH. In one example, each SSB burst within the first plurality of SSB bursts is transmitted using a same half-frame index.

In one example, different SSB bursts within the first plurality of SSB bursts are transmitted using different half-frame indices. In one example, each SSB burst within the first plurality of SSB bursts is associated with a CORESET #0 for scheduling SIB1. In one example, a designated SSB burst in the first plurality of SSB bursts, comprising a regular SSB, is associated with a CORESET #0 for scheduling SIB1.

In one example, the designated SSB burst is a last SSB burst in a cluster and is transmitted in a raster frequency. In one example, one or more SSB bursts within the first plurality of SSB bursts are muted based on a predefined muting pattern.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

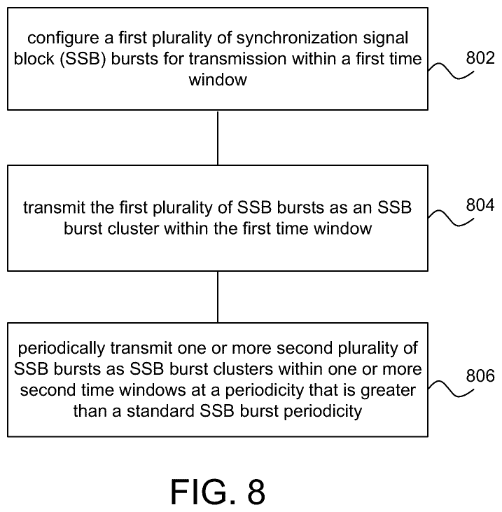

FIG. 8 illustrates a flowchart of a method performed by an NE 700 in accordance with aspects of the present disclosure. The operations of the method may be implemented by a NE 700 as described herein. In some implementations, the NE 700 may execute a set of instructions to control the function elements of the NE 700 to perform the described functions.

At step 802, the method may configure a first plurality of SSB bursts for transmission within a first time window. The operations of step 802 may be performed in accordance with examples as described herein. In some implementations, aspects of the operations of step 802 may be performed by a NE 700, as described with reference to FIG. 7.

At step 804, the method may transmit the first plurality of SSB bursts as an SSB burst cluster within the first time window. The operations of step 804 may be performed in accordance with examples as described herein. In some implementations, aspects of the operations of step 804 may be performed by a NE 700, as described with reference to FIG. 7.

At step 806, the method may periodically transmit one or more second plurality of SSB bursts as SSB burst clusters within one or more second time windows at a periodicity that is greater than a standard SSB burst periodicity. The operations of step 806 may be performed in accordance with examples as described herein. In some implementations, aspects of the operations of step 806 may be performed by a NE 700, as described with reference to FIG. 7.

It should be noted that the method described herein describes one possible implementation, and that the operations and the steps may be rearranged or otherwise modified and that other implementations are possible.

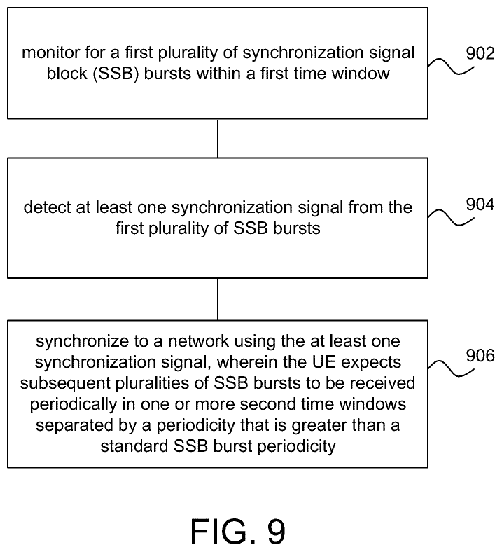

FIG. 9 illustrates a flowchart of a method performed by a UE 500 in accordance with aspects of the present disclosure. The operations of the method may be implemented by a UE 500 as described herein. In some implementations, the UE 500 may execute a set of instructions to control the function elements of the UE 500 to perform the described functions.

At step 902, the method may monitor for a first plurality of SSB bursts within a first time window. The operations of step 902 may be performed in accordance with examples as described herein. In some implementations, aspects of the operations of step 902 may be performed by a UE 500, as described with reference to FIG. 5.

At step 904, the method may detect at least one synchronization signal from the first plurality of SSB bursts. The operations of step 904 may be performed in accordance with examples as described herein. In some implementations, aspects of the operations of step 904 may be performed by a UE 500, as described with reference to FIG. 5.

At step 906, the method may synchronize to a network using the at least one synchronization signal, wherein the UE expects subsequent pluralities of SSB bursts to be received periodically in one or more second time windows separated by a periodicity that is greater than a standard SSB burst periodicity. The operations of step 906 may be performed in accordance with examples as described herein. In some implementations, aspects of the operations of step 906 may be performed by a UE 500, as described with reference to FIG. 5.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
configure a first plurality of synchronization signal block (SSB) bursts for transmission within a first time window;
transmit the first plurality of SSB bursts as an SSB burst cluster within the first time window; and
periodically transmit one or more second plurality of SSB bursts as SSB burst clusters within one or more second time windows at a periodicity that is greater than a standard SSB burst periodicity.

2. The NE of claim 1, wherein each SSB burst in the first plurality of SSB bursts comprises one or more SSBs transmitted within a half-frame of a radio frame.

3. The NE of claim 1, wherein each SSB burst in the first plurality of SSB bursts is separated from another by a configurable time gap defined as an offset in Orthogonal Frequency Division Multiplexing (OFDM) symbols or slots between an end of a last SSB in a preceding burst and a start of a first SSB in a subsequent burst.

4. The NE of claim 1, wherein the periodicity is greater than 40 milliseconds.

5. The NE of claim 1, wherein a number of SSBs transmitted across multiple SSB burst clusters over time is substantially equal to a number of SSBs transmitted using a lower SSB periodicity.

6. The NE of claim 1, wherein at least one SSB burst in the first plurality of SSB bursts comprises a lean SSB that comprises a primary synchronization signal (PSS) and a secondary synchronization signal (SSS) and omits at least a portion of a physical broadcast channel (PBCH).

7. The NE of claim 6, wherein a first SSB burst within a cluster comprises a lean SSB and a second SSB burst within the cluster comprises a regular SSB containing the PSS, SSS, and a full PBCH.

8. The NE of claim 1, wherein each SSB burst within the first plurality of SSB bursts is transmitted using a same half-frame index.

9. The NE of claim 1, wherein different SSB bursts within the first plurality of SSB bursts are transmitted using different half-frame indices.

10. The NE of claim 1, wherein each SSB burst within the first plurality of SSB bursts is associated with a Control Resource Set #0 (CORESET #0) for scheduling System Information Block 1 (SIB1).

11. The NE of claim 1, wherein a designated SSB burst in the first plurality of SSB bursts, comprising a regular SSB, is associated with a Control Resource Set #0 (CORESET #0) for scheduling System Information Block 1 (SIB1).

12. The NE of claim 11, wherein the designated SSB burst is a last SSB burst in a cluster and is transmitted in a raster frequency.

13. The NE of claim 1, wherein one or more SSB bursts within the first plurality of SSB bursts are muted based on a predefined muting pattern.

14. A method of a network equipment (NE), comprising:
configuring a first plurality of synchronization signal block (SSB) bursts for transmission within a first time window;
transmitting the first plurality of SSB bursts as an SSB burst cluster within the first time window; and
periodically transmitting one or more second plurality of SSB bursts as SSB burst clusters within one or more second time windows at a periodicity that is greater than a standard SSB burst periodicity.

15. A user equipment (UE) for wireless communication, comprising:
at least one memory; and
at least one processor coupled with the at least one memory and configured to cause the UE to:
monitor for a first plurality of synchronization signal block (SSB) bursts within a first time window;
detect at least one synchronization signal from the first plurality of SSB bursts; and
synchronize to a network using the at least one synchronization signal,
wherein the UE expects subsequent pluralities of SSB bursts to be received periodically in one or more second time windows separated by a periodicity that is greater than a standard SSB burst periodicity.

16. The UE of claim 15, wherein the at least one processor is configured to cause the UE to detect both lean SSBs and regular SSBs and initiate synchronization upon detection of multiple synchronization signals.

17. The UE of claim 15, wherein the at least one processor is configured to cause the UE to monitor multiple half-frames within a radio frame for detecting SSB bursts transmitted with different half-frame indices.

18. The UE of claim 15, wherein the at least one processor is configured to cause the UE to use synchronization signals received from different SSB bursts within a same cluster to improve time-frequency synchronization prior to decoding a broadcast channel.

19. The UE of claim 15, wherein the at least one processor is configured to cause the UE to decode a Control Resource Set #0 (CORESET #0) associated with an SSB burst within the first plurality of SSB bursts, and to obtain scheduling information for System Information Block 1 (SIB1) based on the CORESET #0.

20. A method of a user equipment (UE), comprising:
monitoring for a first plurality of synchronization signal block (SSB) bursts within a first time window;
detecting at least one synchronization signal from the first plurality of SSB bursts; and
synchronizing to a network using the at least one synchronization signal,
wherein the UE expects subsequent pluralities of SSB bursts to be received periodically in one or more second time windows separated by a periodicity that is greater than a standard SSB burst periodicity.
